(19) United States
(12) Patent Application Publication
(10) Pub. No.: US 2003/0195753 A1
(43) Pub. Date: Oct. 16, 2003

(54) Systems and methods for providing priority customer service

(76) Inventor: Brandon Gabriel Homuth, Richmond, VA (US)

Correspondence Address: Finnegan, Henderson, Farabow,, Garrett & Dunner, L.L.P., 1300 I Street, N.W., Washington, DC, 20005-3315, US

(21) Appl. No.: 10/119,049

(22) Filed: Apr. 10, 2002

(51) Int. Cl. G06F 17/60

(52) U.S. Cl. 705/1

(57) ABSTRACT

Systems and methods are provided for priority-based customer service. In such systems and methods, incoming calls are received from customers. For each incoming call, the customer may be provided with an offer of priority service. Priority service may be offered to all customers, either at all times or when wait times exceed a predetermined value. Alternatively, priority service may only be offered to certain customers. If the customer accepts the offer of priority service, the customer is then placed in a call queue for service based on the priority accepted. If the customer does not accept priority service, the customer is placed at the end of the queue, or otherwise handled as the call would have been had priority customer service not been offered.

### BACKGROUND OF THE INVENTION

1. Field of the Invention

The present invention generally relates to systems and methods for providing customer service. More particularly, the invention relates to systems and methods for providing priority-based customer service.

2. Description of the Related Art

Many businesses today offer one or more forms of customer service through systems such as customer call centers. For example, by calling a telephone number or line associated with a credit card company, customers may be able to check their available credit line, obtain an address for mailing payment and/or speak to a customer service representative regarding questions they have, such as billing questions. Customer call centers are also used by other types of businesses. For instance, by calling a telephone line associated with an entertainment venue, such as a movie theater or a ticket-merchandiser, customers may be able to obtain information about upcoming events, reserve seats or tickets for an event and/or purchase tickets. As another example, a consumer product manufacturer or retailer, such as a computer company or a washing machine manufacturer, may provide a customer service line to permit customers to obtain information about warranties and/or schedule service or installation of a newly purchased product.

Services offered to customers by telephone may be implemented with an automated system to provide various services such as automated message services for information on upcoming events or addresses for mailing payment. Services offered by businesses may also permit a customer to interact with a customer service representative to obtain information, purchase products or receive other services. In short, telephony-based, customer service systems may offer a wide variety of potential services for customers of any type of business.

Despite the ubiquity of telephony-based, customer service systems, customers using such systems often face long delays when calling. This is because most customer service systems can only handle a certain volume of calls at one time. For example, the number of telephone lines entering an automated response system may be limited and/or the number of available customer service representatives may be limited. Customers calling during when call volume exceeds the available resources may receive a message indicating that all lines are busy and/or that all customer service representatives are busy. Frequently, for customer service systems experiencing frequent extended wait times, customers may be provided with an estimated wait time. For example, upon calling a customer service system, a customer may hear an automated message indicating the expected wait time before receiving any service.

The situation of large call volume coupled with limited resources poses disadvantages for both customers and businesses. Further, the problem is likely to increase as more businesses provide services to customers via telephony-based systems. Customers, however, who face extended wait times are faced with the choice of foregoing service by hanging up or waiting extended periods of time on hold to receive service. Businesses, on the other hand, are faced with losing potential business from customers or disturbing existing customers who experience long delays and/or choose to hang up rather than wait.

Accordingly, there is a need for improved systems and methods for providing service to customers. There is also a need for systems and methods that allow businesses to offer priority-based customer service, thereby permitting customers to more quickly obtain customer service during high call volume or when service delays are present.

### SUMMARY OF THE INVENTION

Systems and methods consistent with embodiments of the present invention provide priority-based customer service, wherein incoming calls are received from a plurality of customers. For each received call, the customer may be provided with an offer for priority service. Priority service may be offered to all customers, either at all times or when wait times exceed a predetermined value. Alternatively, priority service may only be offered to certain customers. If the customer accepts the offer for priority service, the customer is then placed in a call queue for service based on the priority accepted. If the customer does not accept priority service, then the customer is placed at the end of the queue, or otherwise handled as the call would have been had priority customer service not been offered.

Additional features and embodiments of the invention will be set forth in part in the description which follows, and in part will be obvious from the description, or may be learned by practice of the embodiments of the invention. It is to be understood that both the foregoing general summary and the following detailed description are exemplary and explanatory only and are not restrictive of the embodiments of the invention, as claimed. Further features and/or variations may be provided in addition to those set forth herein. For example, embodiments of the invention may be directed to various combinations and sub-combinations of the disclosed features and/or combinations and sub-combinations of several further features disclosed below in the detailed description.

### BRIEF DESCRIPTION OF THE DRAWINGS

The accompanying drawings, which are incorporated in and constitute a part of this specification, illustrate various embodiments of the present invention, and, together with the description, serve to explain features and aspects of the invention. In the drawings:

FIG. 1 is a block diagram of an exemplary system for providing priority customer service, consistent with embodiments of the invention; and

FIG. 2 is a flow chart of an exemplary method for providing priority customer service, consistent with embodiments of the invention.

### DETAILED DESCRIPTION

Systems and methods consistent with embodiments of the present invention allow a business to offer priority customer service, thereby relieving or eliminating the wait time customers are exposed to when seeking service. By offering priority service, businesses can lessen the chance that potential business will be lost and/or that existing customers will be disturbed when seeking service from a customer call center.

Generally, systems and methods consistent with embodiments of the present invention provide priority-based service, wherein incoming calls are received from customers. For each incoming call, the customer may be provided with an offer for priority service. Priority service may be offered to all customers, either at all times or when wait times exceed a predetermined value. Alternatively, priority service may only be offered to certain customers. For example, customers that are likely to be revenue-generating customers may be offered priority service. Additionally, different levels of priority may be offered. For instance, a customer may be offered multiple levels of priority, or alternatively, a different level of priority may be offered depending on the customer. If the customer accepts the offer of priority service, the customer is then placed in a call queue for service based on the priority accepted. If the customer does not accept priority service, the customer is placed at the end of the queue, or otherwise handled as the call would have been had priority customer service not been offered.

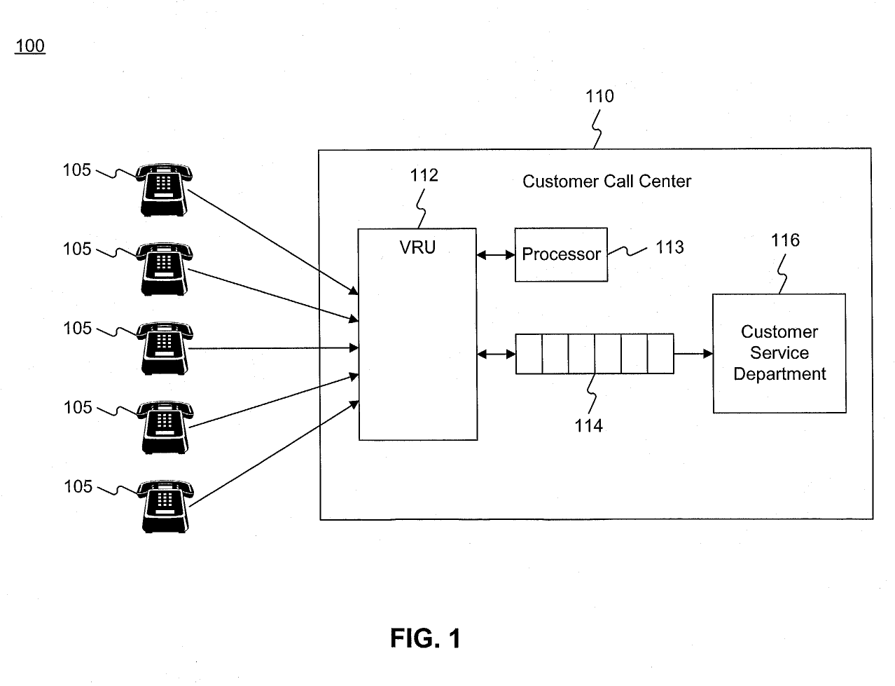

By way of a non-limiting example, FIG. 1 illustrates an exemplary system environment 100 for implementing embodiments of the present invention. As illustrated in FIG. 1, system 100 includes a customer call center 110 for receiving incoming calls placed by a plurality of telephones 105. Each of the plurality of telephones 105 may represent the telephone of a customer for calling a predetermined customer service telephone number or, alternatively, may represent available incoming telephone lines to customer call center 110. Although only five telephones 105 are depicted in FIG. 1, it should be understood that any number of telephones or telephone lines may be provided, consistent with embodiments of the present invention. Further, although not depicted in FIG. 1, telephones 105 may be implemented as a standard, dual tone multi-frequency (DTMF) phone, a wireless phone or a mobile phone, and/or may communicate with customer call center 110 through a communication network or combination of networks (such as a PBX, a PSTN and/or a mobile or cellular communication network).

As illustrated in FIG. 1, customer call center 110 may include an automated voice response unit (VRU) 112, a processor 113, a call queue 114, and a customer service department 116. VRU 112 is adapted to receive incoming calls from the plurality of telephones 105. VRU 112 then places incoming calls in call queue 114. The placement of calls in call queue 114 may be determined by the VRU 112 and/or processor 113. While FIG. 1 illustrates processor 113 as being a separate component from VRU 112, processor 113 may be integrated and/or provided as part of VRU 112. Calls are then taken in order by customer service department 116 from call queue 114.

In addition to receiving incoming calls, VRU 112 may be configured to gather information from a customer. For example, upon calling a credit card company, and prior to proceeding to customer service, VRU 112 may gather information such as the credit card number or account number about which the customer is calling. The gathered information may then be used by VRU 112 to route the call appropriately or may be used to assist a customer service representative in accessing account information. Additionally, VRU 112 may provide the customer with automated information. For example, VRU 112 may greet the customer and/or offer the customer with one or more menus that assist VRU 112 in routing the call appropriately. For example, customer call center 110 may be equipped to handle calls in English, Spanish and/or other languages. VRU 112 may provide a customer with a choice of pressing one digit to proceed in English, another digit for Spanish, etc. VRU 112 may also provide the customer with information about the expected wait time before receiving the desired service. In one embodiment, VRU 112 may determine an expected wait time by multiplying the number of preceding calls in call queue 114 by a predetermined number representing the average wait time. Finally, VRU 112 puts incoming calls into call queue 114.

Processor 113 may be used in conjunction with VRU 112 to determine the ordering of calls in call queue 114. Alternatively, VRU 112 may be configured to determine the ordering of calls without the use of processor 113. In an exemplary call queue, calls are simply put at the end of the queue and picked up by the customer service department 116 from the front of the queue (i.e., calls may be handled in the queue according to a first-in, first-out (FIFO) methodology). Systems and methods consistent with embodiments of the invention, however, may alter this queue behavior to provide priority-based customer service.

In one embodiment, callers to customer call center 110 may be offered priority customer service if the expected wait time, as calculated by VRU 112, exceeds a certain predetermined value. For example, priority customer service may be offered to each caller if the expected wait time exceeds twenty minutes. VRU 112 may then offer priority service to the customer. The customer may be told that while the expected wait time exceeds twenty minutes, the customer can receive guaranteed service within, for example, five minutes by paying a nominal fee, such as $2. If the customer wishes to accept this priority service, the customer may be told to press a certain digit on their telephone. If the customer denies the offered priority service, the customer may either press another digit or simply stay on the line. If VRU 112 receives an indication that the customer has accepted the priority, VRU 112 may then collect information from the customer to obtain payment. Alternatively, payment information may be collected when the customer completes the customer service transaction. In yet another embodiment, VRU 112 may have already gathered the customer's credit card number or other billing information about the customer. In such a case, the credit card number may be automatically charged or the customer otherwise automatically billed. Other forms of payment or consideration may also be provided as a fee for the priority service, such as frequent flyer miles, credits or reward points. After any necessary payment or consideration information is received, processor 113 determines what position in call queue 114 the call needs to be placed in order to provide the promised service to the customer.

VRU 112 and/or processor 113 may implemented using any computing-based platform, such as a personal computer, a workstation, or a mainframe computer to perform various functions and operations, such as those disclosed herein. By way of example, VRU 112 and/or processor 113 may be implemented by a general purpose computer selectively activated or reconfigured by a computer program stored in the computer or may be a specially constructed computing platform for carrying-out the features and operations disclosed herein. VRU 112 and/or processor 113 may also be implemented or provided with a wide variety of components or subsystems including, for example, one or more of the following: one or more central processing units, a co-processor, a memory, registers, and other data storage and/or processing devices and subsystems.

Call queue 114 may be implemented according to any known method for implementing a queue, such as a linked list or an array. Call queue may be adapted to permit calls to be placed into the queue at any point, not just at the end of call queue. Further, while only one call queue 114 is depicted in FIG. 1, it should be understood that systems and methods consistent with embodiments of the invention may have any number of call queues. For example, there may be a call queue 114 associated with each language (e.g., English, Spanish, etc.) in which customers may receive service. Alternatively, there may be a call queue 114 for each of a certain class of callers. For example, in a customer call center 110 associated with a credit card company, there may be a call queue 114 associated with regular accounts, a call queue 114 associated with delinquent or collection accounts, and/or a call queue 114 associated with premium or platinum accounts. In yet another embodiment, there may be a number of call queues 114 each associated with a different priority of customer service. For example, there may be a first call queue 114 for customers who decline priority customer service and a second call queue 114 for customers who accept priority customer service, from which calls are answered more quickly.

Customer service department 116 may represent customer service representatives and/or automated customer service resources. As described above, there may be more than one call queue 114 in customer call center 110 and, therefore, there may also be more than one customer service department 116. For example, there may be a customer service department 116 or a set of customer service representatives associated with each call queue 114. Additionally, automated service equipment may also be associated with each call queue 114 to handle calls from customers.

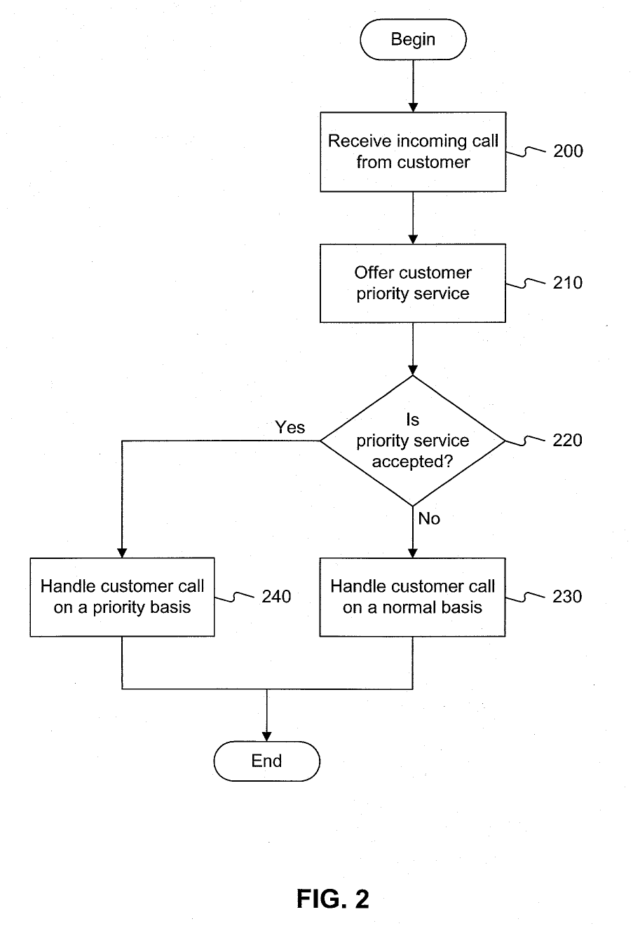

In accordance with embodiments of the present invention, an exemplary process for providing priority-based customer service will now be described with reference to FIG. 2. As shown in FIG. 2, customer call center 110 may first receive an incoming call from a customer via one of the plurality of telephones 105 (step 200). As described above, VRU 112 accepts the incoming call and may gather information from the customer. Further, VRU 112 may provide the customer with information, such as expected wait time before receiving service.

VRU 112 and/or processor 113 may then offer to the customer a priority service (step 210). For example, a priority service may be offered to all customers if the expected wait time exceeds a certain predetermined threshold, such as twenty minutes. Alternatively, priority service may be offered to all customers regardless of expected wait times. In yet another embodiment, different levels of priority service may be offered. For example, for a first nominal fee, such as $2, the customer may be guaranteed service within five minutes. For a second nominal fee, such as $5, the customer may be guaranteed service within two minutes. In such an embodiment, the customer may be instructed to press one digit on their phone to obtain the first level of customer service or press another digit to obtain the second level of customer service. In still another embodiment, different levels of priority service may be based on the class of customer. For example, regular customers may be offered priority service for a first fee, whereas premium or platinum customers may be offered priority service for a second fee, which may be less than the first fee. Finally, customers may also be given the option of obtaining an annual or lifetime priority service, for example by paying a larger fee. For example, by paying $20 as a one-time or annual fee, the customer may be given an alternate phone number to call for customer service that will place the customer automatically at or near the front of the queue.

After the one or more types of priority customer service are offered, VRU 112 determines if the offer of priority service has been accepted (step 220). The customer may indicate acceptance of the offer by pressing a certain digit on their telephone or may be requested to speak a certain word that is recognized by VRU 112 or a separate VRU system (such as a VRU system associated with customer service department 116). The customer may similarly decline the offer by pressing a certain digit or by speaking a certain word, or further, may simply remain on the line without any further action.

If the offer of priority service is declined, the customer call is handled on a normal or non-priority basis (step 230). For example, if the customer call center 110 includes a single call queue 114, the customer call may be placed at the end of call queue and handled on a normal basis (such as on a FIFO basis). In systems having more than one call queue 114, VRU 112 may place the call at the end of the appropriate queue. For example, if customer call center 110 includes a call queue 114 for English calls and a call queue 114 for Spanish calls, VRU 112 would place the call at the end of whichever call queue 114 was appropriate, based on information provided by the customer. By way of another example, if the customer call center 110 includes a call queue for priority calls and a main call queue for normal handling, VRU 112 may place the customer call at the end of the non-priority queue so that the call is handled on a normal basis.

If the offer of priority service is accepted, the customer call is handled on a priority basis (step 240). For example, VRU 112 may place the customer call in the appropriate position of call queue 114 based on the accepted priority. Prior to being placed in call queue 114, the customer may need to provide billing and/or other information to pay for the accepted priority. After any necessary payment information is gathered by VRU 112, processor 113 and/or VRU 112 may determine the appropriate position of the call in call queue 114. For example, if the priority accepted guaranteed service within five minutes and a single call queue is provided at the customer call center, processor 113 may determine which call queue position would satisfy this guarantee. For example, processor 113 may determine the appropriate position by dividing five minutes by an average call length to determine the furthest position back in the queue the call should be placed. Processor 113 and/or VRU 112 may also determine which call queue 114 the priority call belongs in. For example, if there is a call queue for priority customer service and a separate call queue for non-priority service, the customer call would be placed in the appropriate position of the call queue for priority service.

While embodiments of the invention has been described in a general context and with reference to specific examples (such as customer call centers for credit card customers), unlimited implementations and modifications are possible. For example, systems and methods consistent with embodiments of the invention may be used with a ticket-merchandiser. When a customer calls, the customer may obtain general information about shows, games or performances for which tickets are available. To reserve or purchase tickets, the customer may need to speak to a customer service representative. By accepting priority service, the customer may be moved to a priority queue or moved to or near the front of a single call queue, thereby increasing the probability that the customer will receive better seats. Similarly, systems and methods consistent with the present invention may be used to reserve tee times for a golf course, purchase airline tickets, make dinner or hotel reservations or purchase or reserve other goods or services. In another embodiment, systems and methods of the present invention may be used with a consumer product manufacturer. Upon calling a customer call center (such as customer call center 110), the customer would be asked whether the customer was seeking technical support for the product or whether the customer was trying to purchase and/or have installed a new product. For the customer seeking technical support, priority service may be offered at a first fee. For the customer trying to purchase or install a new product, priority service may be offered at a second, lesser fee, since this type of call is more likely to generate greater revenue for the consumer product manufacturer.

The above-noted features and other aspects of the embodiments of the present invention may be implemented in various systems or network environments to provide automated priority service for customers. Such environments and applications may be specifically constructed for performing various processes and operations of the embodiments of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

It will be apparent to those skilled in the art that various modifications and variations can be made to the embodiments of the invention without departing from the scope or spirit of the invention. For example, criteria other than an expected wait time may be used to determine whether to offer priority service to a customer. Further, the fee or consideration for a priority service offered to a customer may take forms other than money. For instance, a customer may be given the option to elect priority service by redeeming or applying credits, reward points or frequent flyer miles.

Other modifications and embodiments of the invention will be apparent to those skilled in the art from consideration of the specification and practice of the embodiments of the invention disclosed herein. Therefore, it is intended that the specification and examples be considered as exemplary only, with a true scope and spirit of the invention being indicated by the following claims.

What is claimed is:

1. A method for providing priority customer service in a telephony-based customer service environment, the method comprising:
receiving an incoming call from a customer;
offering priority customer service to the customer;
handling the call from the customer on a normal basis if the customer declines the offered priority customer service; and
handling the call from the customer on a priority basis if the customer accepts the offered priority customer service.

2. The method of claim 1, wherein the step of offering priority customer service to the customer comprises:
determining an expected wait time for providing service to the customer; and
providing an offer of priority service to the customer if the expected wait time exceeds a predetermined value.

3. The method of claim 2, wherein the step of providing an offer of priority customer service comprises:
providing the customer with a guarantee of service in a time less than the expected wait time upon payment of a fee.

4. The method of claim 2, wherein the step of providing an offer of priority service comprises:
providing the customer with a guarantee of service in a first time upon payment of a first fee; and
providing the customer with a guarantee of service in a second time upon payment of a second fee,
wherein the first time is greater than the second time and the second fee is greater than the first fee.

5. The method of claim 1, wherein the customer service environment includes a call queue of calls from customers awaiting service, and wherein the step of handling the call on a normal basis comprises placing the call from the customer at a first position of the call queue if the customer declines the offered priority customer service, and further wherein the step of handling the call on a priority basis comprises placing the call from the customer at a second position of the call queue if the customer accepts the offered priority customer service.

6. The method of claim 1, wherein the customer service environment includes a priority call queue for calls handled on a priority basis and a main call queue for calls handled on a normal basis, and wherein the step of handling the call on a normal basis comprises placing the call from the customer in the main call queue if the customer declines the offered priority customer service, and further wherein the step of handling the call on a priority basis comprises placing the call from the customer in the priority call queue if the customer accepts the offered priority customer service.

7. A system for providing priority customer service in a telephony-based customer service environment, the system comprising:
means for receiving an incoming call from a customer;
means for offering priority customer service to the customer;
means for handling the call from the customer on a normal basis if the customer declines the offered priority customer service; and
means for placing the call from the customer on a priority basis if the customer accepts the offered priority customer service.

8. The system of claim 7, wherein the means for offering priority customer service to the customer comprises:
means for determining an expected wait time for providing service to the customer; and
means for providing an offer of priority service to the customer if the expected wait time exceeds a predetermined value.

9. The system of claim 8, wherein the means for providing an offer of priority customer service comprises:
means for providing the customer with a guarantee of service in a time less than the expected wait time upon payment of a fee.

10. The system of claim 8, wherein the means for providing an offer of priority service comprises:
means for providing the customer with a guarantee of service in a first time upon payment of a first fee; and
means for providing the customer with a guarantee of service in a second time upon payment of a second fee,
wherein the first time is greater than the second time and the second fee is greater than the first fee.

11. The system of claim 7, wherein the customer service environment includes a call queue of calls from customers awaiting service, and wherein the means for handling the call on a normal basis comprises means for placing the call from the customer at a first position of the call queue if the customer declines the offered priority customer service, and further wherein the means for handling the call on a priority basis comprises means for placing the call from the customer at a second position of the call queue if the customer accepts the offered priority customer service.

12. The system of claim 7, wherein the customer service environment includes a priority call queue for calls handled on a priority basis and a main call queue for calls handled on a normal basis, and wherein the means for handling the call on a normal basis comprises means for placing the call from the customer in the main call queue if the customer declines the offered priority customer service, and further wherein the means for handling the call on a priority basis comprises means for placing the call from the customer in the priority call queue if the customer accepts the offered priority customer service.

13. A system for providing priority customer service in a customer call center, the customer call center including a customer service department, the system comprising:
a plurality of telephone lines for receiving incoming calls from customers;
at least one call queue for ordering calls to be taken by the customer service department; and
an automated voice response unit (VRU), connected between the plurality of telephone lines and the at least one call queue, for accepting calls from the plurality of telephone lines and placing the accepted calls in the call queue,
wherein the VRU is configured to offer priority customer service to the customers.

14. The system of claim 13, further comprising:
a processor for assisting the VRU in placing the accepted calls in the call queue.

15. The system of claim 13, wherein the VRU is configured to perform the following steps:
receive an incoming call from a customer;
offer priority service to the customer;
place the call from the caller at a first position of the call queue if the customer declines the offered priority customer service; and
place the call from the caller at a second position of the call queue if the customer accepts the offered priority customer service.

16. The system of claim 15, wherein the VRU is further configured to:
determine an expected wait time for customer service; and
provide an offer of priority service to the customer if the expected wait time exceeds a predetermined value.

17. The system of claim 16, wherein the VRU, upon providing an offer of priority customer service, is further configured to:
provide the customer with a guarantee of service in a time less than the expected wait time upon payment of a fee.

18. The system of claim 16, wherein the VRU, upon providing an offer of priority customer service, is further configured to:
provide the customer with a guarantee of service in a first time upon payment of a first fee; and
provide the customer with a guarantee of service in a second time upon payment of a second fee,
wherein the first time is greater than the second time and the second fee is greater than the first fee.

19. The system of claim 13, further comprising a priority call queue for calls handled on a priority basis and a main call queue for calls handled on a normal basis.

20. The system of claim 19, wherein the VRU is configured to perform the following steps:
receive an incoming call from a customer;
offer priority service to the customer;
place the call from the caller in the main call queue if the customer declines the offered priority customer service; and
place the call from the caller in the priority call queue if the customer accepts the offered priority customer service.
